(19) United States
(12) Patent Application Publication
(10) Pub. No.: US 2009/0098498 A1
(43) Pub. Date: Apr. 16, 2009

(54) SYSTEM FOR PRODUCING CEMENT CLINKER

(76) Inventors: Tobias Klegraf, Ruthen (DE); Markus Mohr, Dulmen (DE); Ralf Osburg, Beckum (DE)

Correspondence Address: STITES & HARBISON PLLC, 1199 NORTH FAIRFAX STREET, SUITE 900, ALEXANDRIA, VA, 22314, US

(21) Appl. No.: 12/159,305

(22) PCT Filed: May 21, 2007
(86) PCT No.: PCT/EP07/04495

§ 371 Date: Sep. 26, 2008

(30) Foreign Application Priority Data
May 22, 2006 (DE) 10 2006 023 980.6

(51) Int. Cl. F27B 7/20; C04B 7/43

(52) U.S. Cl. 432/106; 432/58

(57) ABSTRACT

The system according to the invention for producing cement clinkers from raw cement mix is composed substantially of a pre-warmer for pre-warming the raw cement mix, a calcination device for pre-calcining the pre-warmed raw cement mix, a sintering kiln for firing the pre-calcined raw cement mix to form cement clinkers, and a cooler for cooling the fired cement clinker. Additionally provided between the cooler and the calcination device is a tertiary air line via which tertiary air is supplied to the calcination device. The calcination device is additionally traversed by the waste gases of the sintering kiln and has a calcining nozzle in its inlet region. Also provided are means for setting the cross section of the calcining nozzle, which means are formed by at least one element which is arranged in a rotatable or pivotable fashion in order to set the cross section and which is exposed to the waste gases of the sintering kiln.

The invention relates to a system for producing cement clinker from raw meal, comprising a preheater for preheating the raw cement meal, a calcining device for precalcining the preheated raw meal, a sintering furnace for firing the precalcined raw cement meal to form cement clinker and a cooler for cooling the fired cement clinker.

On the one hand, the exhaust gases from the sintering furnace flow through the calcining device, and on the other hand tertiary air is supplied to the latter via a tertiary-air line provided between the cooler and the calcining device. As the temperature and above all the oxygen content of these two gas flows vary greatly, it is known to provide a slider in the tertiary-air line in order to be able to adjust the distribution between exhaust gas and tertiary air. The calcining device additionally has, in its inlet region, a calcining nozzle which is usually formed by a constriction in the ascending pipe. The selected cross-sectional area of the calcining nozzle forms a compromise on the basis of the flow conditions to be expected during start-up, under partial load and during rated operation. During system operation, the gas distribution is finely adjusted solely by means of the tertiary-air slider. If the operation of the system deviates greatly from the design point, there is the risk that adjustment of the gas distribution via the movement of the tertiary-air slider will no longer be possible. This is usually the result of deposits of clinker dust in the tertiary-air line caused by longer-term partial-load operation. On the other hand, an increase in the gas velocity in the calcining nozzle is desirable when using lumpy fuels.

In order to control the nozzle cross-section, it is currently state of the art to vary the nozzle cross-section while the furnace system is at a standstill by adding or removing the refractory lining.

A further possible means of reducing the nozzle cross-section is to insert hollow sections with a refractory lining into the nozzle region. Although access to the calciner is not required during this process for adjustment of the nozzle, system stoppage is also necessary in this case.

A further arrangement known from practice provides a plurality of flat sliders installed in the region of the nozzle. They are made of a refractory material and can be displaced horizontally, whereby the calcining nozzle can be specifically adjusted. In this embodiment, relatively complex sealing is necessary, which only allows manual actuation of the flat sliders.

Therefore, the object of the invention is to develop further the means for adjusting the cross-section of the calcining nozzle so that adjustment of the nozzle is possible in a simple manner during operation of the system.

According to the invention, this object is achieved by the features of claim 1.

The system according to the invention for producing cement clinker from raw cement meal substantially comprises a preheater for preheating the raw cement meal, a calcining device for precalcining the preheated raw cement meal, a sintering furnace for firing the precalcined raw cement meal to form cement clinker and a cooler for cooling the fired cement clinker. A tertiary-air line, via which tertiary air is supplied to the calcining device, is additionally provided between the cooler and the calcining device. Moreover, the exhaust gases from the sintering furnace flow through the calcining device, which has a calcining nozzle in its inlet region. Furthermore, means for adjusting the cross-section of the calcining nozzle are provided and are formed by at least one element which, for adjustment of the cross-section, is rotatably or pivotably arranged and is exposed to the exhaust gases from the sintering furnace.

A rotatably or pivotably arranged means for adjusting the cross-section of the calcining nozzle can be sealed substantially more simply and more reliably than a horizontally displaceable flat slider and is less susceptible to deposits. Furthermore, the element can be displaced in a simple, in particular automated manner during operation of the calcining device.

Further configurations of the invention form the subject-matter of the sub-claims.

According to a preferred configuration of the invention, two elements arranged opposite one another are provided for adjusting the cross-section. Moreover, the at least one element for adjusting the cross-section is formed and arranged so that it is actuatable from outside during operation of the calcining device.

Furthermore, the at least one element for adjusting the cross-section is preferably mounted on both sides. Moreover, the at least one element for adjusting the cross-section is arranged in the region of a convexity of the calciner, wherein the element is at least partially rotatable or pivotable into the convexity in order to increase the size of the calcining nozzle.

In a further configuration, means are provided for cooling the at least one element for adjusting the cross-section.

In one embodiment, the element for adjusting the cross-section is formed by a pendulum which is pivotable in such a way that it effects a change in the cross-section of the calcining nozzle. In another embodiment, the element is formed by a cylinder section or cylinder portion. Furthermore, it is possible for the element to comprise a segment-type plate. However, the element does not necessarily have to be rotationally symmetrically formed.

The elements for adjusting the cross-section are preferably protected against heat and wear. Means for protection against chemical attack can also be provided. The movable elements for changing the cross-section can be driven via, for example, their rotation or pivoting axis or via their circumference.

Further advantages and configurations of the invention will be further described in the following with the aid of the description of a number of embodiments and the drawings, wherein:

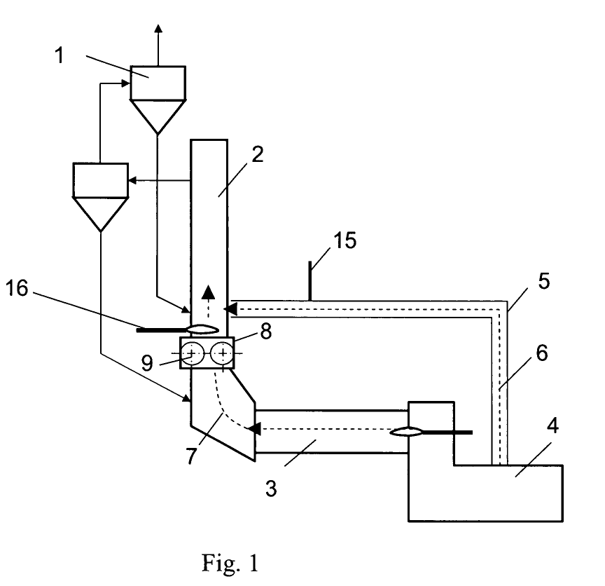

FIG. 1 shows a schematic view of a system for producing cement clinker;

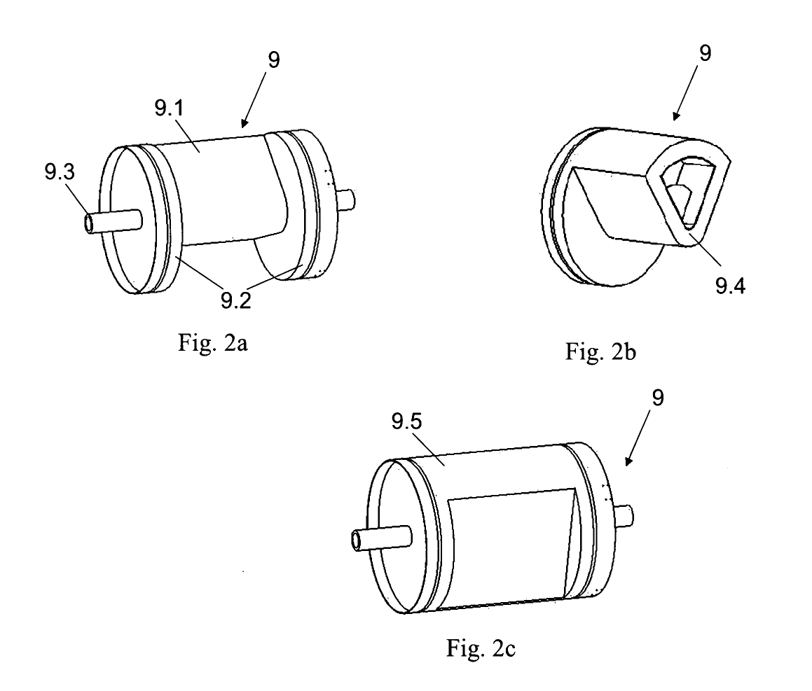

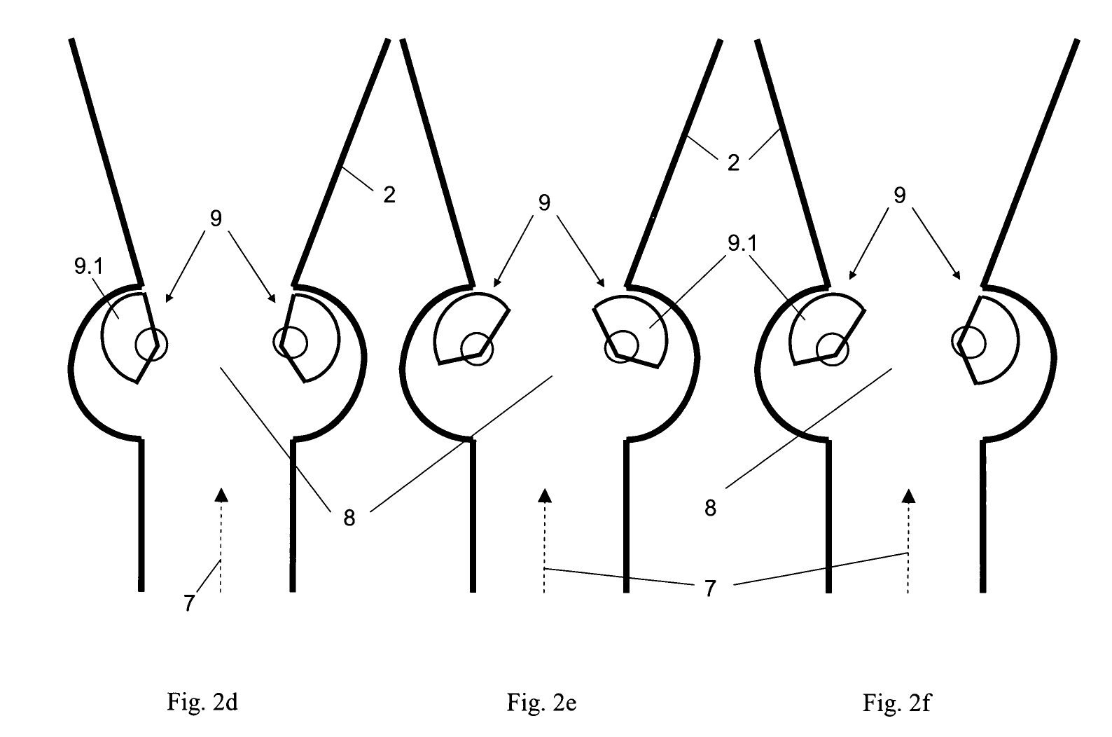

FIG. 2a shows a three-dimensional view of an element, formed as a cylinder segment, for adjusting the cross-section of the calcining nozzle;

FIG. 2b shows a sectional view of the element according to FIG. 2a;

FIG. 2c shows a three-dimensional view of an element, formed as a cylinder section or cylinder portion, for adjusting the cross-section of the calcining nozzle according to a further embodiment;

FIGS. 2d-2f show schematic views of the means for adjusting the cross-section of the calcining nozzle in different positions;

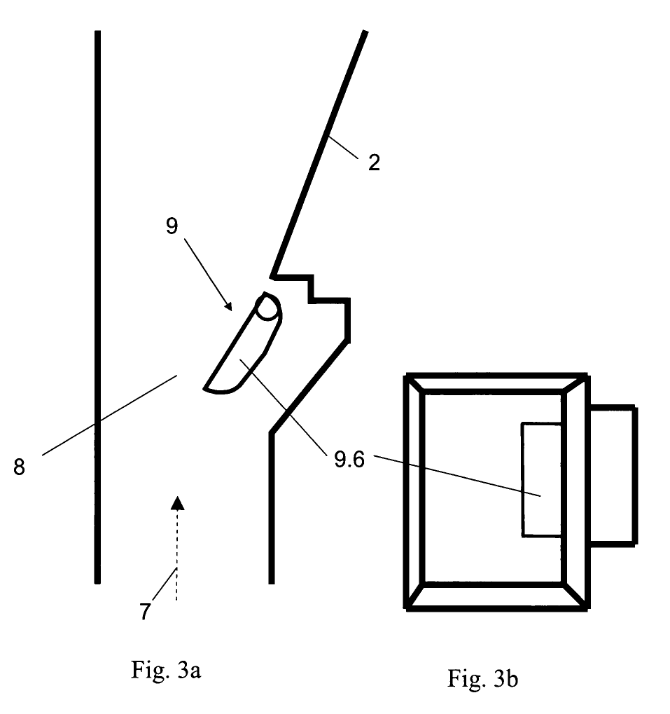

FIGS. 3a+3b show a two-dimensional view and a plan view of an element, formed as a pendulum, for adjusting the cross-section of the calcining nozzle;

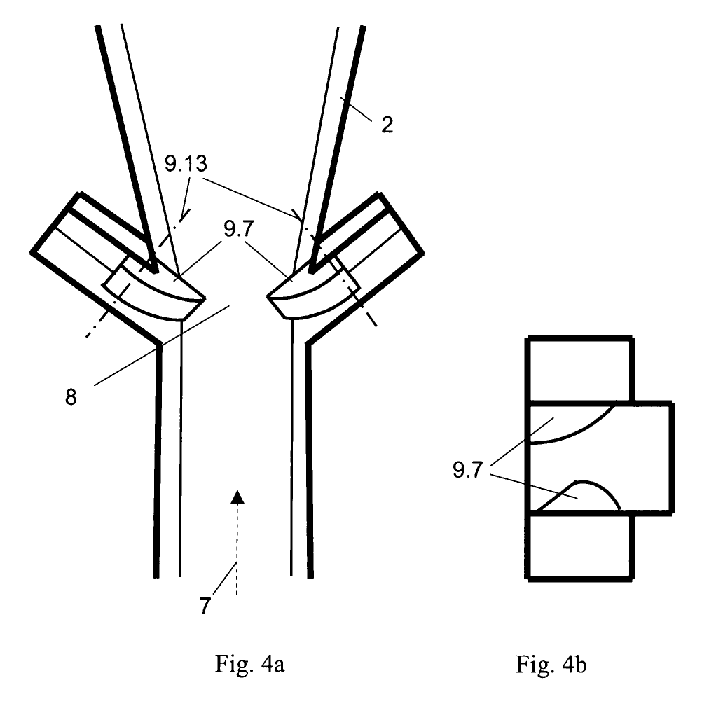

FIGS. 4a+4b show different views of an element, formed as a segment-type plate, for adjusting the cross-section of the calcining nozzle;

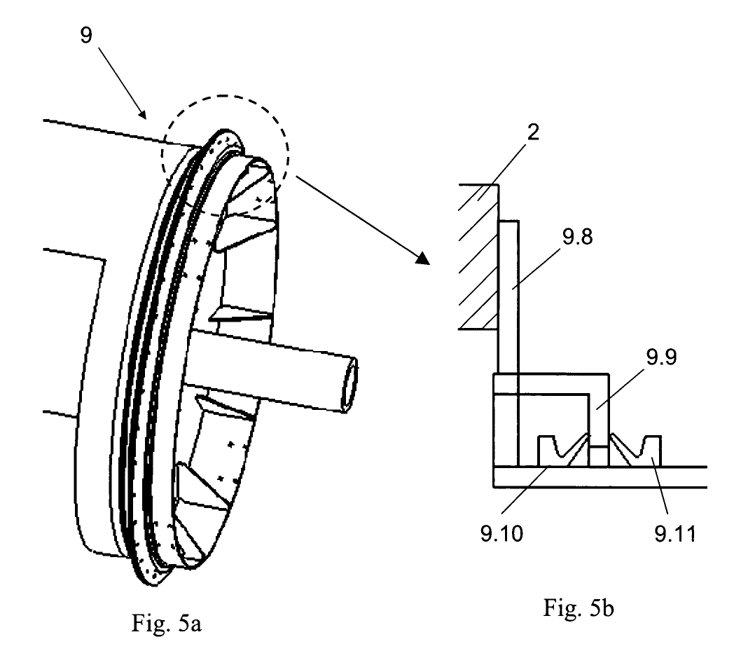

FIG. 5a shows a three-dimensional view of the element for adjusting the cross-section of the calcining nozzle in the region of the connection to the housing of the calcining device;

FIG. 5b shows a sectional detail view in the region of the seal;

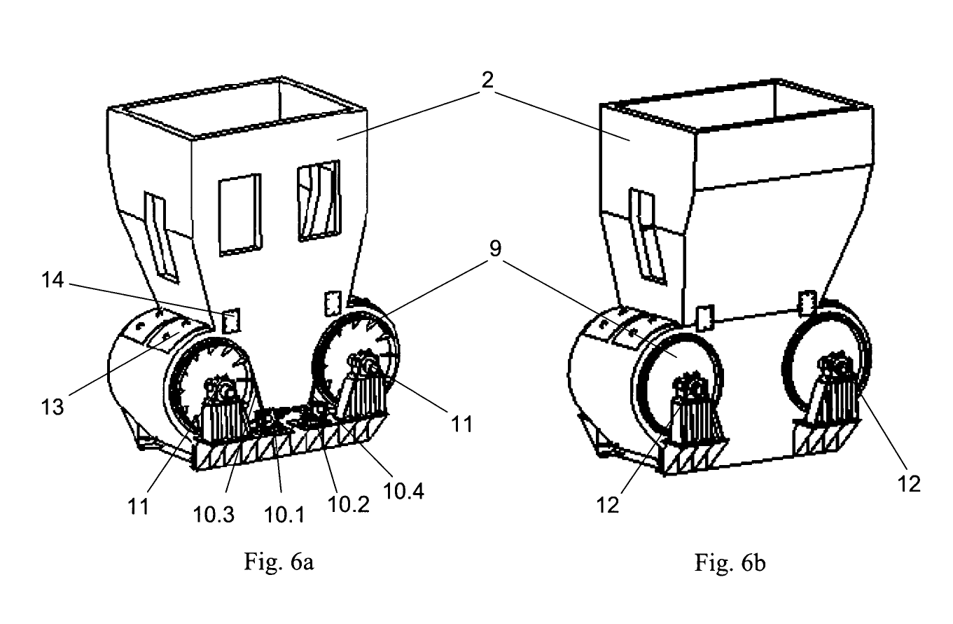

FIGS. 6a+6b show three-dimensional front and rear views of the calcining device in the region of the calcining nozzle; and

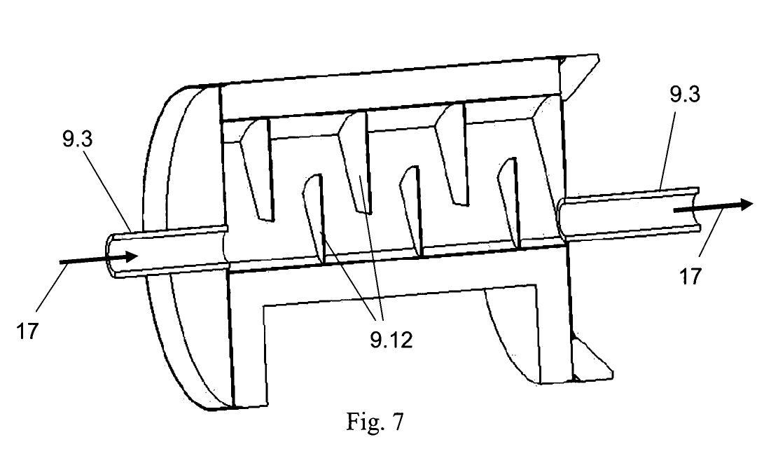

FIG. 7 shows a sectional three-dimensional view of an element for adjusting the cross-section of the calcining nozzle, in which an embodiment of the means for cooling the element can be seen.

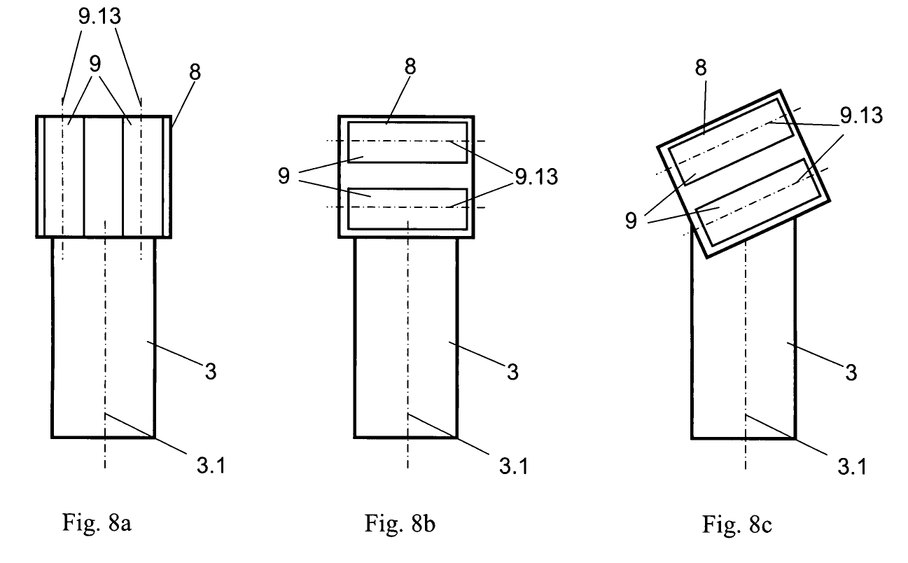

FIGS. 8a-8c show a schematic plan view of a system for producing cement clinker, with different arrangements of the elements for adjusting the cross-section of the calcining nozzle relative to the furnace axis.

The system shown in FIG. 1 for producing cement clinker from raw cement meal substantially comprises a preheater 1 for preheating the raw cement meal, a calcining device 2 for precalcining the preheated raw cement meal, a sintering furnace 3 for firing the precalcined raw cement meal to form cement clinker and a cooler 4 for cooling the fired cement clinker.

Furthermore, a tertiary-air line 5 is provided between the cooler 4 and the calcining device 2 in order to be able to supply tertiary air 6 to the calcining device.

In addition, exhaust gases 7 from the sintering furnace 3 flow through the calcining device 2. In its inlet region, the calcining device has a calcining nozzle 8. In order to be able to adjust the gas distribution between furnace exhaust gas 7 and tertiary air 6, on the one hand a slider or other adjusting means 15 is provided in the tertiary-air line 5 and on the other hand means for adjusting the cross-section of the calcining nozzle are arranged in the region of the calcining nozzle 8. These means for adjusting the cross-section of the calcining nozzle are formed by at least one element 9 which, for adjustment of the cross-section, is rotatably or pivotably arranged and is exposed to the exhaust gases 7 from the sintering furnace 3.

Different embodiments of the element 9 for adjusting the cross-section of the calcining nozzle will now be further described in the following.

The element 9 shown in FIG. 2a for adjusting the cross-section of the calcining nozzle is formed by a cylinder section or cylinder portion, in particular a cylinder segment 9.1. This cylinder segment, which in particular can have an angle in the range from 90° to 180°, is closed at both ends by a respective cylindrical end plate 9.2. The element 9 is mounted in the region of the calcining nozzle by means of a shaft or two shaft journals 9.3 so that the element 9 can execute a rotating movement. FIGS. 2d-2f show various adjustment possibilities for the element 9 in the region of the calcining nozzle 8.

In the embodiment shown, two elements 9 arranged opposite one another are provided for adjustment of the cross-section. Within the scope of the invention, however, it is naturally also possible to provide only one element or more than two elements.

In FIG. 2d, the two elements 9 are set so that the greatest possible cross-section is produced for the calcining nozzle 8. In FIG. 2e, the cross-section is reduced by both elements 9, whereas in FIG. 2f the cross-section is reduced on one side. By unilaterally actuating the elements 9, deflection of the exhaust-gas flow 7 can also be effected in addition to changing the cross-section. As a result, the calcining device has an additional degree of freedom in guiding the flow of the exhaust gases in order to ensure better mixing conditions in the region of the calcining burner 16.

As can be seen from FIG. 2b in particular, the element 9 is preferably formed as a hollow body provided with a refractory casing 9.4 so that the element can withstand the hot exhaust gases 7, which have a temperature above 1000° C. Moreover, the formation as a hollow body provides the possibility of cooling, as will be explained in further detail later with the aid of FIG. 7.

While the element 9 according to FIGS. 2a and 2b is formed as a cylinder segment 9.1, it is naturally also possible to provide a differently formed cylinder section or cylinder portion 9.5, as shown in FIG. 2c by way of example. As a general principle, the element 9 essentially only has to be constructed so that it can effect a change in the cross-section of the calcining nozzle by means of a rotating or pivoting movement.

In the embodiment according to FIGS. 3a and 3b, the element 9 for adjusting the cross-section of the calcining nozzle is formed as a pendulum 9.6 which is pivotable in such a way that it effects a change in the cross-section of the calcining nozzle.

FIGS. 4a-4b show an embodiment in which the elements 9 for adjusting the cross-section of the calcining nozzle are formed by segment-type plates 9.7 which are rotatably mounted in order to change the cross-section of the calcining nozzle 8. The angle between the rotation axis 9.13 and the flow direction of the exhaust gases 7 preferably lies in the range between 0 and 60°.

The element 9 is mounted on the housing of the calciner 2, wherein seals are used which are either arranged directly on the shaft or the shaft journals 9.3 or are arranged in the region of the circumference, in particular in the region of the end plates 9.2, of the element 9.

FIG. 5a shows a portion of the element 9 in the region of its connection to the housing of the calciner 2. A detail of this connection is shown more closely in FIG. 5b. In particular, the element 9 has a flange 9.8 which is fixedly connected at one end to the housing 2. The other end of the flange is formed as a counter-running surface 9.9 for the rotatable part of the element 9. In this case, sealing is effected by an internal and an external seal 9.10, 9.11. The two seals rotate together with the rotatable part of the element 9 and are formed as V-rings, for example.

Other seals are naturally also possible within the scope of the invention.

The element 9 for adjusting the cross-section is preferably mounted on both sides, wherein it is advantageously held in the region of its shaft or its shaft journals 9.3 in two bearings arranged outside the calcining device 2.

The element 9 is advantageously driven on the outside of the calcining device and, according to the configuration of the element 9, can be driven via its shaft or shaft journals 9.3 or via its circumference, wherein suitable means 10 are to be provided for driving the element 9.

In the embodiment shown, a drive motor 10.1 and 10.2 is associated with each element 9 and is connected via a respective drive train 10.3, 10.4 to the circumference of the rotatable element 9, which is guided out through the housing of the calcining device 2. For this purpose, suitable drivers for the drive train are provided on the circumference of the element 9. The drive train can be formed by a chain drive or a rack-and-pinion drive, for example.

Furthermore, closable openings 13, 14 are provided in the region of the calcining nozzle 8 in order to be able to carry out any necessary inspections or maintenance. Moreover, it is possible to remove any deposits via these openings. The formation of deposits in the region of the elements 9 can, however, also be counteracted by cyclical actuation of the elements 9.

According to a preferred configuration, the elements 9 coming into contact with the hot exhaust gases 7 are cooled. In this case, the element 9 is formed for example as a hollow body, as schematically indicated in FIG. 7. A cooling medium 17, for example cooling air or water, is advantageously supplied via the shaft or the shaft journals 9.3. By arranging suitable deflection members 9.12 inside the element 9, the cooling effect can be increased. The cooling medium can be supplied via the one shaft stub 9.3 and discharged via the other shaft stub. Unilateral supply and discharge of the cooling medium is also possible.

The elements 9 not only effect a change in the amount of exhaust gas, but also permit specific adjustment of the gas velocity in the lower region of the calcining device. An increase in the gas velocity is desirable in the region of the calciner, for example when burning lumpy fuels.

The relative arrangement of the elements 9 for adjusting the cross-section of the calcining nozzle 8 in relation to the axis of symmetry 3.1 of the furnace is shown in FIGS. 8a-8c. The axis of symmetry 3.1 does not necessarily have to be aligned with the rotation axes 9.13 of the elements 9, as shown in FIG. 8a, or form a right angle, as shown in FIG. 8b. The arrangement of the elements for adjusting the cross-section of the calcining nozzle can also be system-specific.

The elements 9 for adjusting the cross-section are advantageously arranged in the region of a convexity of the calciner, wherein the elements 9 are at least partially rotatable or pivotable into the convexity in order to increase the size of the calcining nozzle 8.

The above-described rotatable or pivotable element 9 for adjusting the cross-section of the calcining nozzle 8 is distinguished above all by a very simple structure and simple sealing in relation to the environment. Consequently, the element 9 can also be adjusted from outside during operation of the calcining device. By means of a suitable control device, the position of the slider 15 for adjusting the amount of tertiary air and the adjustment of the cross-section of the calcining nozzle 8 can be adapted to one another in an automated manner in order to react at any time to changing operating conditions.

1. A system for producing cement clinker from raw cement meal, comprising
a. a preheater for preheating the raw cement meal,
b. a calcining device for precalcining the preheated raw cement meal,
c. a sintering furnace for firing the precalcined raw cement meal to form cement clinker and
d. a cooler for cooling the fired cement clinker,
e. wherein a tertiary-air line, via which tertiary air is supplied to the calcining device, is provided between the cooler and the calcining device, and
f. wherein the exhaust gases from the sintering furnaces flow through the calcining device, which has a calcining nozzle in its inlet region, and
g. means are also provided for adjusting the cross-section of the calcining nozzle, which means are formed by at least one element which, for adjustment of the cross-section, is rotatably or pivotably arranged and is exposed to the exhaust gases from the sintering furnace,
characterized in that the at least one element for adjusting the cross-section is arranged in the region of a convexity of the calciner, wherein the element is partially rotatable or pivotable into the convexity in order to increase the size of the calcining nozzle.

2. An apparatus according to claim 1, characterized in that the at least one element for adjusting the cross-section is mounted on both sides.

3. An apparatus according to claim 1, characterized in that the at least one element for adjusting the cross-section is arranged in the region of a convexity of the calciner, wherein the element is at least partially rotatable or pivotable into the convexity in order to increase the size of the calcining nozzle.

4. An apparatus according to claim 1, characterized in that two elements arranged opposite one another are provided for adjusting the cross-section.

5. An apparatus according to claim 1, characterized in that means are provided for cooling the at least one element for adjusting the cross-section.

6. An apparatus according to claim 1, characterized in that the at least one element for adjusting the cross-section is formed by a pendulum which is pivotable in such a way that it effects a change in the cross-section of the calcining nozzle.

7. An apparatus according to claim 1, characterized in that the at least one elements for adjusting the cross-section is formed by a cylinder section or cylinder portion which is rotatable in such a way that it effects a change in the cross-section of the calcining nozzle.

8. An apparatus according to claim 1, characterized in that the at least one element for adjusting the cross-section is formed by a segment-type plate which is rotatable in such a way that it effects a change in the cross-section of the calcining nozzle.

9. An apparatus according to claim 1, characterized in that the at least one movable element for adjusting the cross-section is protected against heat and wear.

10. An apparatus according to claim 1, characterized in that the at least one movable element for adjusting the cross-section is provided with driving means on its circumference.
